(19) United States
(12) Patent Application Publication
(10) Pub. No.: US 2004/0150131 A1
(43) Pub. Date: Aug. 5, 2004

(54) Concrete block surface treatment machine

(76) Inventor: Wallace Grubb, St. Basile-Le-Grand (CA)

Correspondence Address: LESPERANCE & MARTINEAU, 1440 WEST, STE-CATHERINE ROOM 700, MONTREAL, QC, H3G1R8, CA

(21) Appl. No.: 10/762,262

(22) Filed: Jan. 23, 2004

Related U.S. Application Data
(60) Provisional application No. 60/442,806, filed on Jan. 28, 2003.

(51) Int. Cl. B28B 11/08; B29C 37/00

(52) U.S. Cl. 264/138; 425/385

(57) ABSTRACT

The concrete block surface treatment machine is used for treating selected exposed surfaces of a concrete block. The machine comprises a frame and an elongated hammer member defining opposite first and second extremities spacedly carried by the frame, and an intermediate portion located between the first and second extremities. The machine also includes a mounting device mounting the hammer member first and second extremities to the frame to allow movement of the hammer member intermediate portion between a first position in which the hammer member intermediate portion clears the concrete block, and a second position in which the hammer member intermediate portion impacts the concrete block. The machine further includes a selectively powered hammer actuator carried by the frame and capable of selectively moving the hammer member intermediate portion between the first and second positions.

### CROSS-REFERENCE DATA

The present patent application claims the priority under the Paris Convention of co-pending provisional patent application No. 60/442,806 filed on Jan. 28, 2003.

### FIELD OF THE INVENTION

The present invention relates to a machine for re-surfacing concrete blocks, and more particularly to a machine for re-surfacing concrete blocks without tumbling the blocks.

### BACKGROUND OF THE INVENTION

Concrete blocks re-surfacing machines are used to provide a so-called antique look to concrete blocks, by artificially wearing and chipping the visible exposed surfaces of the concrete blocks so as to provide them with a similar rough appearance than that of wild, naturally developed stone blocks.

The artificial wearing of the concrete blocks has been conventionally done by tumbling the blocks in large hollow rotating drums wherein a number of blocks are inserted. As the drum rotates, the blocks will collide within the drum, thus damaging one another and wearing their outer surfaces to provide the desired antique appearance. A problem with these conventional tumbler concrete-block wearing apparatuses is that the concrete blocks are often damaged to an extent that they cannot be used for their intended structural purpose anymore.

To circumvent this problem, another type of concrete block wearing apparatus has been developed, wherein the concrete blocks are conveyed through a wearing area on a linear conveyor. Block surface or edge treatment machines are provided along the conveyor to artificially wear selected surfaces and/or edges of the blocks. These treatment machines include rotatable shafts that are driven into high-speed rotation near the concrete blocks. The shafts support chains that are flailed against selected surfaces and/or edges of the concrete blocks repeatedly to wear the concrete blocks due to the impacting chains. These chain flailing machines however have the problem that the chains will wear a concrete block very locally and often in a very regular manner due to the constant movement of the rotary chains, which will result in blocks being similarly worn and looking alike, thus partly defeating the purpose of trying to provide a unique antique look to the blocks.

### SUMMARY OF THE INVENTION

The present invention relates to a concrete block surface treatment machine for treating selected exposed surfaces of a concrete block, comprising:

a frame;

an elongated hammer member defining opposite first and second extremities spacedly carried by said frame, and an intermediate portion located between said first and second extremities;

mounting means mounting said hammer member first and second extremities to said frame to allow movement of said hammer member intermediate portion between a first position wherein said hammer member intermediate portion is destined to clear an adjacent concrete block to be surface-treated, and a second position wherein said hammer member intermediate portion is destined to impact the concrete block to be surface-treated; and

a selectively powered hammer actuator carried by said frame and capable of selectively moving said hammer member intermediate portion between said first and second positions.

In one embodiment, said mounting means also allow movement of said hammer member first and second extremities between said first and second positions, with said hammer actuator moving said first and second extremities concomitantly with said intermediate portion.

In one embodiment, said hammer member comprises an elongated support element carrying a number of strikers at said hammer member intermediate portion, said strikers being movable with respect to one another and destined to impact the concrete block to be surface-treated.

In one embodiment, said support element is flexible and loosely carried by said frame.

In one embodiment, said support element is a chain and said strikers are chain links.

In one embodiment, said support element is a chain and said strikers are a number of rigid striker rings that each define a central bore engaged by said chain.

In one embodiment, said support element is a rigid rod and said strikers are rigid striker rings that each define a central bore loosely engaged by said rigid rod whereby said striker rings are movable relative to one another and relative to said rod.

In one embodiment, said mounting means comprises a reciprocating hammer support which may be displaced by said hammer actuator in a reciprocating motion to correspondingly displace said hammer member intermediate portion between said first and second positions.

In one embodiment, said hammer support is reciprocatingly pivotable in an arc between first and second positions corresponding to first and second positions of said hammer member intermediate portion.

In one embodiment, said concrete block surface treatment machine further comprises at least one additional elongated hammer member defining opposite first and second extremities spacedly carried by said frame, and an intermediate portion located between said first and second extremities;

wherein said mounting means also mount said additional hammer member first and second extremities to said frame to allow movement of said additional hammer member intermediate portion between a first position wherein said additional hammer member intermediate portion is destined to clear an adjacent concrete block to be surface-treated, and a second position wherein said additional hammer member intermediate portion is destined to impact the concrete block to be surface-treated; and wherein said selectively powered hammer actuator is capable of selectively moving said additional hammer member intermediate portion between said first and second positions.

In one embodiment, said mounting means comprise hammer supports that are shared by the first-named said hammer member and by said additional hammer member.

The present invention further relates to a concrete block surface treatment machine for treating selected exposed surfaces of a concrete block, comprising:

a frame;

a hammer member;

mounting means mounting said hammer member to said frame while allowing movement of said hammer member between a first position wherein said hammer member is destined to clear an adjacent concrete block to be surface-treated, and a second position wherein said hammer member is destined to impact the concrete block to be surface-treated; and

a selectively powered hammer actuator carried by said frame and capable of selectively moving said hammer member between said first and second positions; wherein the movement of said hammer member between said first and second positions comprises a reciprocating movement component.

In one embodiment, said hammer member is elongated and defines opposite first and second extremities spacedly carried by said frame, and an intermediate portion located between said first and second extremities.

The invention also relates to a method for surface-treating a concrete block, comprising the following steps:

a) positioning the concrete block in front of a concrete block surface treatment machine; and

b) reciprocatingly moving at least one hammer member between a first position wherein said hammer member clears the concrete block, and a second position wherein said hammer member impacts the concrete block.

In one embodiment, said hammer member comprises an elongated support member defining opposite first and second extremities spacedly carried by a frame of said concrete block surface treatment machine, and an intermediate portion located between said first and second extremities and carrying a number of striker rings each having a central bore loosely engaged by said elongated support element, wherein step (b) of the method of the present invention further comprises loosely moving said striker rings relative to said elongated support element and relative to one another for allowing said striker rings to impact said concrete block without the movement of said support element directly impacting said concrete block.

### DESCRIPTION OF THE DRAWINGS

In the annexed drawings:

FIG. 1 is a top plan view of a block treating and handling system according to the present invention, with the overhead block pressure means being mostly removed to show the underlying conveyor carrying concrete blocks to be surface-treated;

FIG. 2 is an end elevation of the block treating and handling system of FIG. 1, with the overhead block pressure means being shown;

FIG. 3 is an enlarged front perspective view of the block surface treatment machine according to the present invention;

FIG. 4 is a rear partly exploded perspective view of the block surface treatment machine of FIG. 3 with its frame being mostly removed to more clearly show the hammer members, the hammer mounting means and the hammer actuator;

FIG. 5 is an enlarged perspective view of one hammer member;

FIG. 6 is a top plan view of the hammer member of FIG. 5; and

FIG. 7 is cross-sectional view of the hammer member taken along lines VII-VII of FIG. 6.

### DETAILED DESCRIPTION OF THE EMBODIMENTS

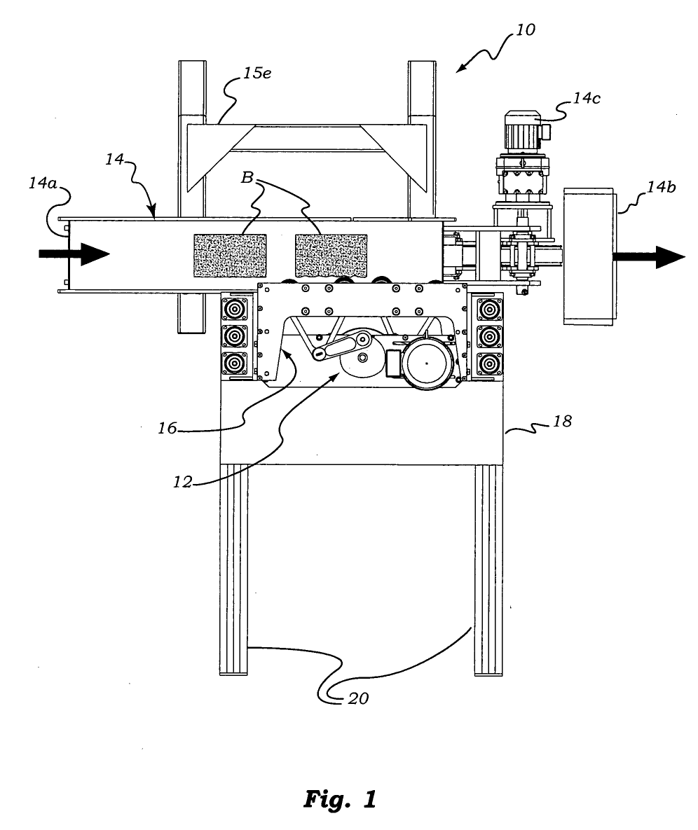

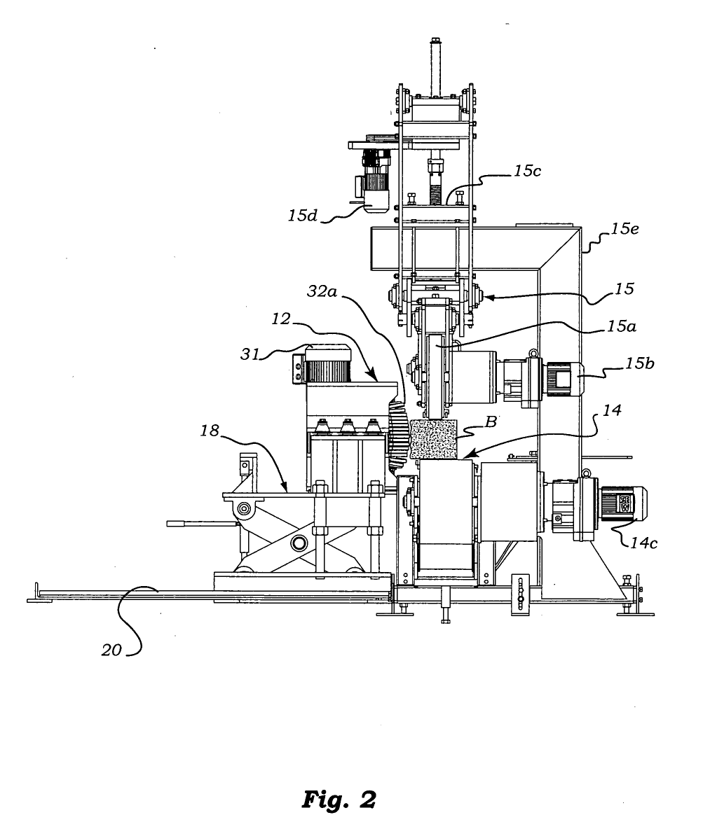

FIGS. 1 and 2 show a block treating and handling system 10 for surface-treating exposed surfaces of concrete blocks B, including a concrete block surface treatment machine 12, a conveyor 14 extending adjacent concrete block surface treatment machine 12, and a vertical spring-loaded block pressure means 15. Conveyor 14 can be of any suitable conventional type, for example including an endless belt that conveys concrete blocks B from an upstream extremity thereof 14a to a downstream extremity thereof 14b, and a conveyor belt motor 14c powering the conveyor belt. Spring-loaded block pressure means 15 is also of known construction and includes a downwardly biased conveying wheel 15a that engages the upper surface of a concrete block B being conveyed adjacent to concrete block surface treatment machine 12 to apply downward pressure thereon, to securely hold each concrete blocks B between wheel 15a and conveyor 14 while block B is being surface-treated as described hereinafter. Wheel 15a is rotated by a motor 15b so as to help convey block B all the while retaining same against conveyor 14, and is downwardly biased by means of a spring device 15c which has a vertically adjustable position by means of a motor 15d and which is mounted on a ground-engaging frame 15e.

As shown in FIGS. 1-4, concrete block surface treatment machine 12 comprises a frame 16 carried on a suitable ground-resting table 18. Table 18 may have an adjustable height, and may further be provided on tracks 20 to allow its position relative to conveyor 14 to be adjusted.

Frame 16 comprises a bottom wall 22 that is fixed to table 18, two side walls 24, 26 upstanding from bottom wall 22, an upper wall 28 located spacedly over bottom wall 22 and carried by side walls 24, 26, and a cross-sectionally L-shaped intermediate wall 30 extending parallel to lower and upper walls 22, 28 therebetween. A motor 31 is supported by intermediate wall 30.

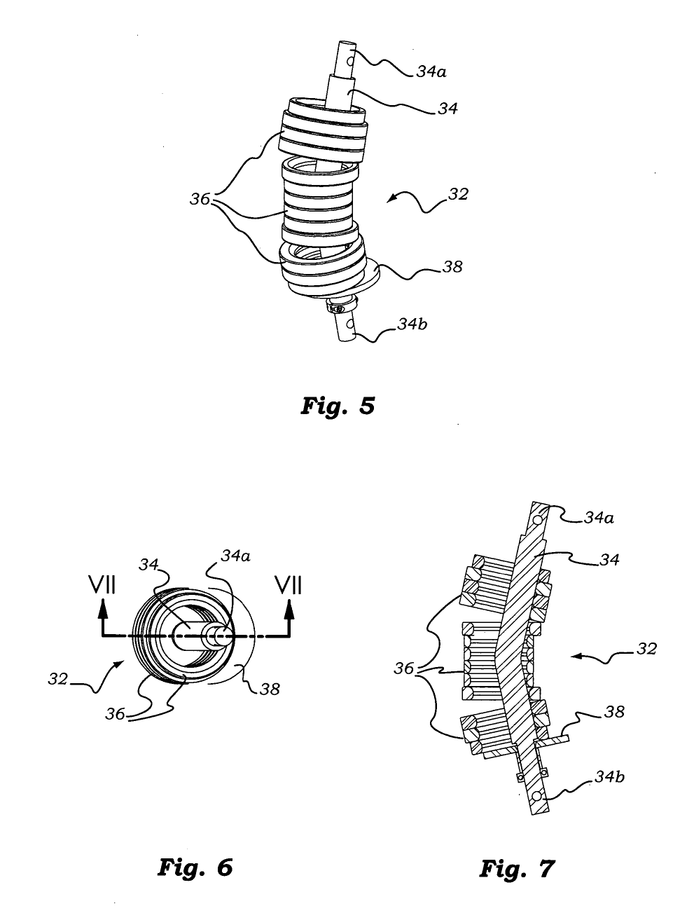

A number of hammer members, for example two pairs of hammer members 32a, 32b and 32c, 32d generally referred to as hammer members 32, are movably carried by frame 16. As shown in FIGS. 5-7, each hammer member 32 comprises an elongated support element in the form of a rigid rod 34 that is elbowed at its midsection and that defines upper and lower extremities 34a, 34b. Rod 34 supports a number of strikers in the form of rigid striker rings 36 that each define a central bore loosely engaged by rigid rod 34. Indeed, it can be seen, particularly in the cross-sectional view of FIG. 7, that the diameter of the central bores of striker rings 36 are significantly larger than the diameter of rigid support rod 34, thus allowing the existence of a significant diametrical play between rod 34 and the inner walls of striker rings 36. This diametrical play allows each striker ring 36 to move relative to striker rod 34, and relative to the other striker rings of the same hammer member 32. The striker rings 36 are stacked upon a ring support plate 38 fixedly attached near the lower extremity 34b of rod 34. As further shown in FIGS. 5-7, striker rings 36 may have varying configurations, i.e. different diameters, sizes and cross-sections. In the embodiment shown in FIGS. 5-7, the uppermost and lowermost rings 36 have a slightly larger diameter, which may promote the surface treatment of the concrete blocks B near and around their upper and lower edges.

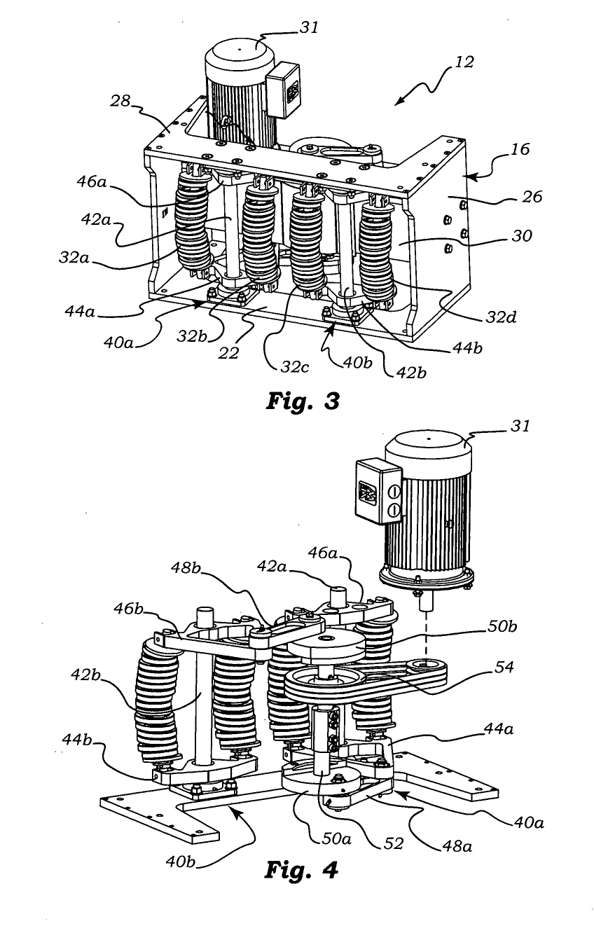

FIGS. 3 and 4 show that hammer members 32 are supported by pairs on pivotable reciprocating mounting means, i.e. hammer members 32a, 32b are mounted on a first mounting means 40a, and hammer members 32c, 32d are mounted on a second mounting means 40b. Mounting means 40a, 40b each comprise a fixed post 42a, 42b extending between the frame bottom and top walls 22, 28. Bottom pivotable supports 44a, 44b are pivotally attached at the bottom end of posts 42a, 42b and upper pivotable supports 46a, 46b are pivotally attached at the upper end of posts 42a, 42b. Lower pivotable support 44a is generally triangular and has two apexes thereof fixedly attached to the rod lower extremities 34b of hammer members 32a, 32b, and its third apex pivotally linked to a lever 48a eccentrically pivotally attached to a cam 50a mounted to a shaft 52 power driven by motor 31 by means of a belt and wheel arrangement 54. Upper pivotable support 46a is linear with two extremities on either side of post 42a that support the respective rod upper extremities 34a of the first pair of hammer members 32a, 32b. Likewise, upper pivotable support 46b is generally triangular and has two apexes thereof fixedly attached to the rod upper extremities 34a of hammer members 32c, 32d, and its third apex pivotally linked to a lever 48b eccentrically pivotally attached to a cam SOb mounted to shaft 52. Lower pivotable support 44b is linear with two extremities on either side of post 42b that support the respective rod lower extremities 34b of the second pair of hammer members 32c, 32d.

In use, concrete blocks B to be surface-treated are sequentially conveyed along conveyor 14 adjacent concrete block surface treatment machine 12. When a concrete block B is located adjacent concrete block surface treatment machine 12, spring-loaded block pressure means 15 will engage concrete block B by means of its biasing wheel 15a that will engage the upper surface of block being B and apply downward pressure thereon, to securely hold block B against conveyor 14.

As block B is thus conveyed on conveyor 14 in facing register with concrete block surface treatment machine 12, it will be repeatedly impacted by hammer members 32. Indeed, hammer members 32 are continuously moved in a reciprocating pivotal displacement between a first retracted position wherein the striker rings 36 of hammer members 32 clear concrete block B, and a second extracted position wherein the striker rings 36 of hammer members 32 impact concrete block B.

More particularly, hammer members 32 are moved between their first and second positions by means of mounting means 40a, 40b and of the hammer actuator that is formed by the combination of motor 31 and its movement transfer elements which include belt and wheel arrangement 54, shaft 52, cams 50a, 50b and levers 48a, 48b. More particularly, powering motor 31 results in its rotational movement being transferred by belt and wheel arrangement 54 to shaft 52, which will in turn rotate the lower and upper cams 50a, 50b. This will move levers 48a, 48b into a reciprocating movement, and levers 48a, 48b will in turn pivot supports 44a, 46b in an arc in one direction, then the other, about their respective posts 42a, 42b. The resulting displacement of hammer members 32a, 32b and 32c, 32d will be a reciprocating pivotal displacement about posts 42a and 42b, respectively. The total angular path of hammer members 32 can be selectively calibrated by adjusting the respective dimensions of pivotable supports 44a, 46b, levers 48a, 48b and cams 50a, 50b, but it can be seen that each hammer member will have a reciprocating movement from its first retracted position wherein it will be located within frame 16, to its second extracted position wherein it will be located outside of frame 16 where it may impact concrete block B. Also, due to the triangular shape of pivotable supports 44a, 46b, when one hammer member 32a, 32c of each pair of hammer members 32a, 32b and 32c, 32d is located in its first retracted position, then the other hammer member 32b, 32d is located in its second extracted position, and vice versa.

Only striker rings 36 will effectively impact concrete block B when a hammer member 32 is in its second extracted position. Indeed, concrete block B is positioned on conveyor 14 at a selected distance from hammer members 32 to allow striker rings 36 to impact concrete block B without striker rings 36 becoming squeezed between concrete block B and rod 34. That is to say, the striker rings 36, that are loosely installed on rod 34, will maintain at least a minimal play between rod 34 and the inner peripheral wall of their inner bore on the side of rod 34 facing concrete block B. Consequently, as the striker rings 36 loosely strike concrete block B, they will slightly damage its outer surface by chipping it, wearing it and marking it, although the full impact of the rods 34 will not be transferred to concrete block B, which prevents blocks B from being excessively damaged.

One particular advantage of the elongated hammer members 32 of the present invention, is that the whole height of concrete block B will be surface-treated simultaneously due to the fact that hammer members 32 can be designed to be long enough for this purpose.

Another particular advantage of the invention, is that the reciprocating movement of elongated hammer members 32 will provide an irregular movement of the stacked striker rings 36, which will result in a correspondingly irregular wear pattern on the concrete block B being treated by machine 12.

In one position of rod 34 shown in the annexed FIGS. 3 and 4, rods 34 have their elbow protruding outwardly of frame 16 towards concrete blocks B. One way of properly setting the height of concrete block surface treatment machine 12 before the surface treatment process commences, is to align the elbow of rods 34 with the mid-height of concrete blocks B. It is noted however that rods 34 could be installed on top and bottom pivotable supports 44a, 44b, 46a, 46b in an inverted position, i.e. with their elbowed portion being oriented inwardly towards frame 16 instead of outwardly towards concrete block B. Different surface treatments can be achieved by installing rod 34 in different positions, or by replacing rod 34 by a striker ring support rod having a different shape, e.g. a straight rod or a rod having an elbow which is more or less angularly accentuated. It is understood that replacing the striker ring support rods may be accomplished in situ if desired.

In an alternate embodiment of the invention, the hammer members could have alternate configurations. One such possible alternate hammer member configuration would comprise a chain replacing the elongated rod 34, with both extremities of the chain being attached to the hammer member mounting means. The chain could engage stacked striker rings in a similar manner than rod 34 engages striker rings 36, or alternately no striker rings could be provided and the chain links themselves could be used to impact the blocks, the strikers then being considered to be the chain links themselves. Other suitable alternate strikers may also be envisioned, as well as other suitable alternate elongated support elements to replace the rods 34 or the chains.

In another alternate embodiment, the hammer actuator and mounting means could differ from the ones shown in the annexed drawings. For example, it could be envisioned to provide a carriage linearly movable along top and bottom tracks provided on the frame top and bottom walls. This carriage would carry the hammer members, which could consequently be moved in a reciprocating linear displacement between a first retracted position and a second extracted position. Any other suitable type of actuator and mounting means assembly may also be envisioned, whereby the hammer members would be moved between a first position wherein at least the intermediate portion of the hammer members would clear an adjacent concrete block to be surface-treated, and a second position wherein said hammer member intermediate portion would impact the concrete block to be surface-treated.

Any further modification to the present invention, which does not deviate from the scope of the appended claims, is considered to be included therein.

1. A concrete block surface treatment machine for treating selected exposed surfaces of a concrete block, comprising:
a frame;
an elongated hammer member defining opposite first and second extremities spacedly carried by said frame, and an intermediate portion located between said first and second extremities;
mounting means mounting said hammer member first and second extremities to said frame to allow movement of said hammer member intermediate portion between a first position wherein said hammer member intermediate portion is destined to clear an adjacent concrete block to be surface-treated, and a second position wherein said hammer member intermediate portion is destined to impact the concrete block to be surface-treated; and
a selectively powered hammer actuator carried by said frame and capable of selectively moving said hammer member intermediate portion between said first and second positions.

2. A concrete block surface treatment machine as defined in claim 1, wherein said mounting means also allow movement of said hammer member first and second extremities between said first and second positions, with said hammer actuator moving said first and second extremities concomitantly with said intermediate portion.

3. A concrete block surface treatment machine as defined in claim 2, wherein said hammer member comprises an elongated support element carrying a number of strikers at said hammer member intermediate portion, said strikers being movable with respect to one another and destined to impact the concrete block to be surface-treated.

4. A concrete block surface treatment machine as defined in claim 3, wherein said support element is flexible and loosely carried by said frame.

5. A concrete block surface treatment machine as defined in claim 4, wherein said support element is a chain and said strikers are chain links.

6. A concrete block surface treatment machine as defined in claim 4, wherein said support element is a chain and said strikers are a number of rigid striker rings that each define a central bore engaged by said chain.

7. A concrete block surface treatment machine as defined in claim 3, wherein said support element is a rigid rod and said strikers are rigid striker rings that each define a central bore loosely engaged by said rigid rod whereby said striker rings are movable relative to one another and relative to said rod.

8. A concrete block surface treatment machine as defined in claim 2, wherein said mounting means comprises a reciprocating hammer support which may be displaced by said hammer actuator in a reciprocating motion to correspondingly displace said hammer member intermediate portion between said first and second positions.

9. A concrete block surface treatment machine as defined in claim 8, wherein said hammer support is reciprocatingly pivotable in an arc between first and second positions corresponding to first and second positions of said hammer member intermediate portion.

10. A concrete block surface treatment machine as define in claim 1, further comprising at least one additional elongated hammer member defining opposite first and second extremities spacedly carried by said frame, and an intermediate portion located between said first and second extremities;
wherein said mounting means also mount said additional hammer member first and second extremities to said frame to allow movement of said additional hammer member intermediate portion between a first position wherein said additional hammer member intermediate portion is destined to clear an adjacent concrete block to be surface-treated, and a second position wherein said additional hammer member intermediate portion is destined to impact the concrete block to be surface-treated; and wherein said selectively powered hammer actuator is capable of selectively moving said additional hammer member intermediate portion between said first and second positions.

11. A concrete block surface treatment machine for treating selected exposed surfaces of a concrete block, comprising:
a frame;
a hammer member;
mounting means mounting said hammer member to said frame while allowing movement of said hammer member between a first position wherein said hammer member is destined to clear an adjacent concrete block to be surface-treated, and a second position wherein said hammer member is destined to impact the concrete block to be surface-treated; and
a selectively powered hammer actuator carried by said frame and capable of selectively moving said hammer member between said first and second positions;
wherein the movement of said hammer member between said first and second positions comprises a reciprocating movement component.

12. A concrete block surface treatment machine as defined in claim 11, wherein said hammer member is elongated and defines opposite first and second extremities spacedly carried by said frame, and an intermediate portion located between said first and second extremities.

13. A concrete block surface treatment machine as defined in claim 12, wherein said hammer member comprises an elongated support element carrying a number of strikers at said hammer member intermediate portion, said strikers being movable with respect to one another and is destined to impact the concrete block to be surface-treated.

14. A concrete block surface treatment machine as defined in claim 13, wherein said support element is a rigid rod and said strikers are rigid striker rings that each define a central bore loosely engaged by said rigid rod whereby said striker rings are movable relative to one another and relative to said rod.

15. A concrete block surface treatment machine as defined in claim 11, wherein said mounting means comprises a reciprocating hammer support which may be displaced by said hammer actuator in a reciprocating motion to correspondingly displace said hammer member between said first and second positions.

16. A concrete block surface treatment machine as defined in claim 15, wherein said hammer support is reciprocatingly pivotable in an arc between first and second positions corresponding to first and second positions of said hammer member.

17. A concrete block surface treatment machine as define in claim 11, further comprising at least one additional elongated hammer member defining opposite first and second extremities spacedly carried by said frame, and an intermediate portion located between said first and second extremities;
wherein said mounting means also mount said additional hammer member first and second extremities to said frame to allow movement of said additional hammer member intermediate portion between a first position wherein said additional hammer member intermediate portion is destined to clear an adjacent concrete block to be surface-treated, and a second position wherein said additional hammer member intermediate portion is destined to impact the concrete block to be surface-treated; and wherein said selectively powered hammer actuator is capable of selectively moving said additional hammer member intermediate portion between said first and second positions.

18. A concrete block surface treatment machine as defined in claim 17, wherein said mounting means comprise hammer supports that are shared by the first-named said hammer member and by said additional hammer member.

19. A method for surface-treating a concrete block, comprising the following steps:
a) positioning the concrete block in front of a concrete block surface treatment machine; and
b) reciprocatingly moving at least one hammer member between a first position wherein said hammer member clears the concrete block, and a second position wherein said hammer member impacts the concrete block.

20. A method for surface-treating a concrete block as defined in claim 19, with said hammer member comprising an elongated support member defining opposite first and second extremities spacedly carried by a frame of said concrete block surface treatment machine, and an intermediate portion located between said first and second extremities and carrying a number of striker rings each having a central bore loosely engaged by said elongated support element, wherein step (b) further comprises loosely moving said striker rings relative to said elongated support element and relative to one another for allowing said striker rings to impact said concrete block without the movement of said support element directly impacting said concrete block.
